(19) United States
(12) Patent Application Publication
(10) Pub. No.: US 2014/0283311 A1
(43) Pub. Date: Sep. 25, 2014

(54) DUAL FUNCTION TOOL

(71) Applicants: Mustapha Ebrahim, North Point (HK); Wen Kwok Wai, Tai Wai (HK); Joel Beebe, Columbus, OH (US); Paul Harrison, Columbus, OH (US)

(72) Inventors: Mustapha Ebrahim, North Point (HK); Wen Kwok Wai, Tai Wai (HK); Joel Beebe, Columbus, OH (US); Paul Harrison, Columbus, OH (US)

(21) Appl. No.: 13/848,053

(22) Filed: Mar. 20, 2013

(51) Int. Cl. B25F 1/00; B25B 7/22

(52) U.S. Cl. CPC B25F 1/003; B25B 7/22
USPC 7/128; 81/305

(57) ABSTRACT

Various embodiments of a dual function tool are disclosed.

### BACKGROUND

When utilizing hand tools, it is often desirable to combine multiple tools into one, so as to reduce weight, space, and clutter for tool storage. Such tools might include pliers, cutters, clamps, crimpers, tongs, or other actuated gripping tools. Likewise, it may be advantageous to include more than one style of gripping tool in a single package so that a user may select a specific tool for a specific need.

What is needed is a gripping tool having a plurality of heads, which may be easily alternated for use.

### SUMMARY

In one embodiment, a dual function tool is provided, the dual function tool comprising: a first handle comprising a first bearing portion; a second handle comprising a second bearing portion; and a first gripping device and a second gripping device, wherein the first gripping device and second gripping device pivot about a central pivot point, and wherein at least one of the first bearing portion and the second bearing portion is configured to transfer force to at least one of the first gripping device and the second gripping device.

In another embodiment, a dual function tool is provided, the dual function tool comprising: a first handle comprising a first bearing portion; a second handle comprising a second bearing portion; a first gripping device and a second gripping device, wherein the first gripping device and second gripping device pivot about a central pivot point, wherein at least one of the first bearing portion and the second bearing portion is configured to transfer force to at least one of the first gripping device and the second gripping device; a first handle linkage member connecting the first handle pivot point to the central pivot point; and a second handle linkage member connecting the second handle pivot point to the central pivot point.

In another embodiment, a dual function tool is provided, the dual function tool comprising: a first handle comprising a first bearing portion; a second handle comprising a second bearing portion; a first gripping device and a second gripping device, wherein the first gripping device and second gripping device pivot about a central pivot point, wherein at least one of the first bearing portion and the second bearing portion is configured to transfer force to at least one of the first gripping device and the second gripping device; a first handle first linkage member and a first handle second linkage member connecting the first handle to the central pivot point; and a second handle first linkage member and a second handle second linkage member connecting the second handle to the central pivot point.

### BRIEF DESCRIPTION OF THE DRAWINGS

The accompanying figures, which are incorporated in and constitute a part of the specification, illustrate various example apparatuses and systems, and are used merely to illustrate various example embodiments. In the figures, like elements bear like reference numerals.

FIG. 1 illustrates a perspective view of an example arrangement of a dual function tool.

FIG. 2 illustrates a perspective view of an example arrangement of handles 102, 104 of dual function tool 100.

FIG. 3 illustrates a perspective view of an example arrangement of pivot system 128 of dual function tool 100.

FIG. 4 illustrates a perspective view of an example arrangement of first gripping device 106 and second gripping device 108 of dual function tool 100.

FIG. 5 illustrates a perspective view of an example arrangement of dual function tool 500 in a first configuration.

FIG. 6 illustrates a perspective view of an example arrangement of dual function tool 500 in a second configuration.

FIG. 7 illustrates a perspective view of an example arrangement of dual function tool 500 in a third configuration.

### DETAILED DESCRIPTION

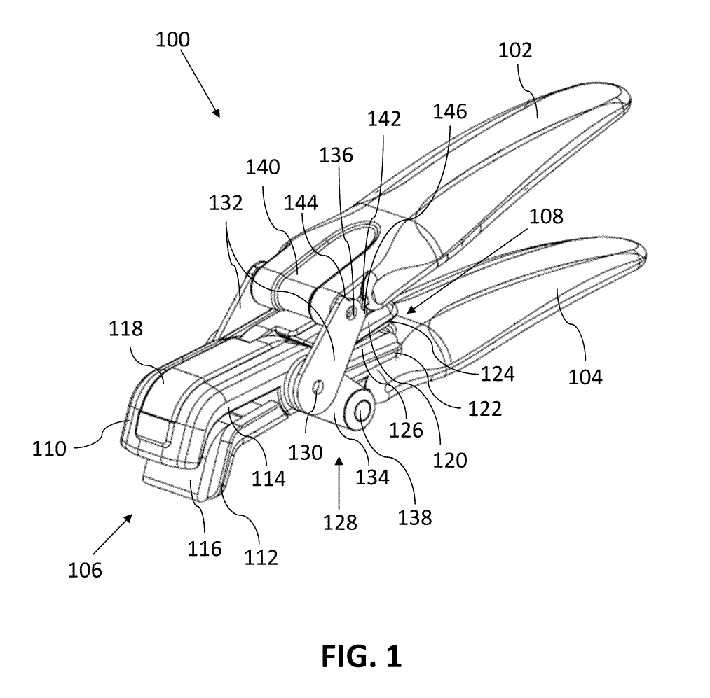

FIG. 1 illustrates a perspective view of an example arrangement of a dual function tool 100, comprising a first handle 102, a second handle 104, a first gripping device 106, and a second gripping device 108.

First handle 102 and second handle 104 may comprise any of a variety of materials, including one or more of a metal, an alloy, a composite, a polymer, or another organic material. First handle 102 and second handle 104 may be at least partially curved or otherwise ergonomically designed to fit the hand of a user. In one embodiment, either of first handle 102 and second handle 104 may comprise resilient panels or finger grooves to aid a user in gripping dual function tool 100.

First gripping device 106 and second gripping device 108 may comprise any of a variety of materials, including one or more of a metal, an alloy, a composite, a polymer, or another organic material. In one embodiment, first gripping device 106 and the second gripping device 108 comprises at least one of: an oven tong, a hot plate tong, a straight tong, an angled tong, a general purpose plier, a needle-nose plier, a tweezer, a scissor, a wire cutter, a wire stripper, a wire crimper, a hose-clamp plier, a split-ring plier, a needle bent-nose plier, a fence plier, a side-cutting plier, an end-cutting plier, a coil crimping plier, a chain plier, a boot clamp plier, a lock ring plier, a crimper, a bolt cutter, a pruner, a compound plier, a lopper, and a clamp.

First gripping device 106 and second gripping device 108 may comprise any of a variety of materials, including one or more of a metal, an alloy, a composite, a polymer, or another organic material. In one embodiment, first gripping device 106 may comprise a first jaw 110 and a second jaw 112. In one embodiment, first jaw 110 and second jaw 112 comprise a pair of opposed surfaces 114 and 116, respectively. In one embodiment, opposed surfaces 114 and 116 may be configured to impart force on an object as opposed surfaces 114 and 116 move toward one another. In another embodiment, opposed surfaces 114 and 116 may be configured to impart force on an object as opposed surfaces 114 and 116 move away from one another. Opposed surfaces 114 and 116 may be configured to provide at least one of a compressive force and a tensile force on an object engaged by opposed surfaces 114 and 116.

In one embodiment, at least one of first gripping device 106 and second gripping device 108 comprise a biasing member biasing opposed surfaces 114 and 116 away from one another. In another embodiment, at least one of first gripping device 106 and second gripping device 108 comprise a biasing member biasing opposed surfaces 114 and 116 toward one another.

In one embodiment, at least one of opposed surfaces 114 and 116 comprises a silicone. The silicone may be configured to provide at least one of a non-marring interface, a heat-resistant interface, and a resilient gripping interface.

In one embodiment, first gripping device 106 comprises a first jaw bearing portion 118. In another embodiment, first gripping device comprises a second jaw bearing portion (not shown).

In one embodiment, second gripping device 108 may comprise a first jaw 120 and a second jaw 122. Second gripping device 108's first jaw 120 and second jaw 122 may be configured similar to first gripping device 106's first jaw 110 and second jaw 112. In one embodiment, first jaw 120 and second jaw 122 comprise a pair of opposed surfaces 124 and 126, which opposed surfaces may be configured similar to opposed surfaces 114 and 116.

In one embodiment, second gripping device 108 comprises a first jaw bearing portion (not shown) and a second jaw bearing portion (not shown).

In one embodiment, dual function tool 100 may comprise a pivot system 128, comprising a central pivot point 130 and at least one linkage member 132, 134 connecting at least one of first handle 102 and second handle 104 to central pivot point 130. In one embodiment, each of first handle 102 and second handle 104 has a corresponding first handle linkage member 132 and second handle linkage member 134 connecting first handle 102 and second handle 104 to central pivot point 130, respectively. In another embodiment, each of first handle 102 and second handle 104 is connected to central pivot point 130 by at least two first handle linkage members 132 and at least two second handle linkage members 134, respectively, which linkage members may be referred to as a first handle first linkage member, first handle second linkage member, second handle first linkage member, and second handle second linkage member, respectively. Pivot system 128 may comprise any of a variety of materials, including one or more of a metal, an alloy, a composite, a polymer, or another organic material.

In one embodiment, first gripping device 106 and second gripping device 108 pivot about central pivot point 130. Central pivot point 130 may comprise an axle upon which first gripping device 106 and second gripping device 108 pivot. In one embodiment, first gripping device 106's first jaw 110 and second gripping device 108's second jaw 122 may be an integral component. In another embodiment, first gripping device 106's second jaw 112 and second gripping device 108's first jaw 120 may be an integral component. In another embodiment, first gripping device 106's first jaw 110 and second gripping device 108's first jaw 120 may be an integral component. In another embodiment, first gripping device 106's second jaw 112 and second gripping device 108's second jaw 122 may be an integral component.

First handle 102 may comprise a first handle pivot point 136, about which first handle linkage member(s) 132 may pivot. First handle pivot point 136 may comprise an axle upon which first handle 102 and first handle linkage member(s) 132 may pivot.

Second handle 104 may comprise a second handle pivot point 138, about which second handle linkage member(s) 134 may pivot. Second handle pivot point 138 may comprise an axle upon which second handle 104 and second handle linkage member(s) 134 may pivot.

In one embodiment, at least one of first handle 102 and second handle 104 comprise a bearing portion. In another embodiment, each of first handle 102 and second handle 104 comprise a bearing portion. In another embodiment, each of first handle 102 and second handle 104 comprise a pair of oppositely oriented bearing portions, wherein one bearing portion is oriented on a first side of a handle and another bearing portion is oriented on a second side of a handle. In another embodiment, first handle 102 comprises a first bearing portion 140. In another embodiment, second handle 104 comprises a second bearing portion (not shown).

In one embodiment, at least one of first bearing portion 140 and the second bearing portion (not shown) are configured to transfer force to at least one of first gripping device 106 and second gripping device 108. For example, first bearing portion 140 and the second bearing portion (not shown) may contact first jaw bearing portion 118 and the second jaw bearing portion (not shown). In one embodiment, bearing portions (not shown) oriented on the medially-facing surfaces of first handle 102 and second handle 104 (e.g., those surfaces facing one another) are configured to contact second gripping device 108's first jaw bearing portion (not shown) and second jaw bearing portion (not shown), such that squeezing first handle 102 and second handle 104 toward one another causes first gripping device 106's first jaw 110 and second jaw 112 to at least one of actuate toward one another or away from one another, depending upon the design of first gripping device 106.

In one embodiment, each of first handle 102 and second handle 104 comprise at least one constraint tab, such as first handle constraint tab 142. The constraint tab may be any raised element or machined channel configured to limit the rotation of handle 102 relative to first handle linkage member(s) 132 and configured to limit the rotation of handle 104 relative to second handle linkage member(s) 134.

In one embodiment, at least one linkage member 132, 134 comprises at least one rotation constraint such as 144, 146 disposed near the proximal end portion of at least one linkage member 132, 134. In another embodiment, at least one linkage member 132, 134 comprises a first rotation constraint 144 and a second rotation constraint 146 disposed near the proximal end portion of at least one linkage member 132, 134. First rotation constraint 144 and second rotation constraint 146 may be angularly separated by θ degrees measured from a datum coaxial with a handle pivot point. In one embodiment, θ is between about 5 degrees and about 180 degrees. In another embodiment, θ is between about 20 degrees and about 140 degrees. In another embodiment, θ is between about 50 degrees and about 110 degrees.

In one embodiment, first rotation constraint 144 and second rotation constraint 146 are oriented on either side of first handle constraint tab 142. First rotation constraint 144 and second rotation constraint 146 prevent the passing of first handle constraint tab 142, such that first handle constraint tab 142 may travel only between first rotation constraint 144 and second rotation constraint 146. In this manner, the rotation of handle 102 relative to first handle linkage member 132 may be limited. As a result, dual function tool 100 may be designed so as to ensure that the pressing together of first handle 102 and second handle 104 exerts force through the first handle bearing portion and second handle bearing portion onto second gripping device 108 such that the first bearing portion and second bearing portion connect in a substantially planar interface to the first jaw bearing portion and the second jaw bearing portion of second gripping device 108.

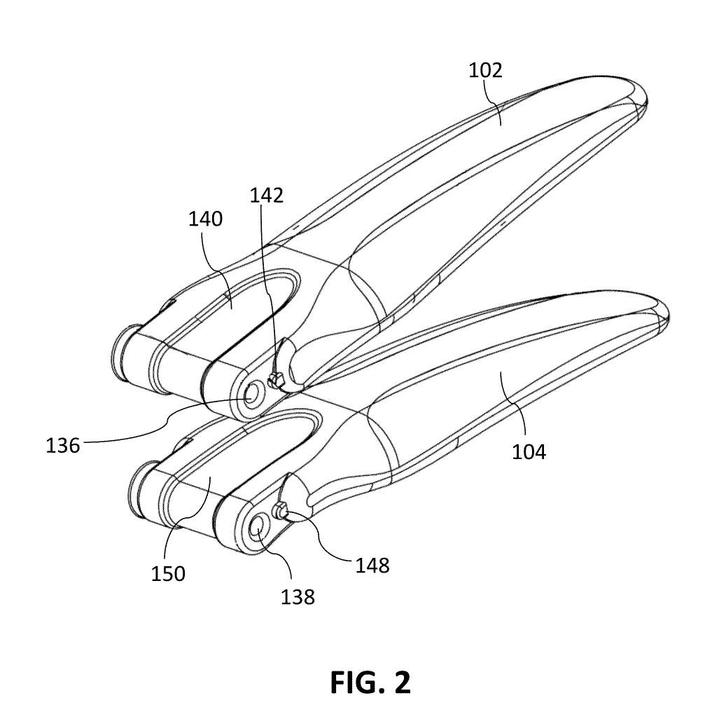

FIG. 2 illustrates a perspective view of an example arrangement of first handle 102 and second handle 104 of dual function tool 100 illustrated in FIG. 1. First handle 102 comprises first handle pivot point 136, first bearing portion 140, and first handle constraint tab 142. Second handle 104 comprises second handle pivot point 138, a second handle constraint tab 148, and a second bearing portion 150.

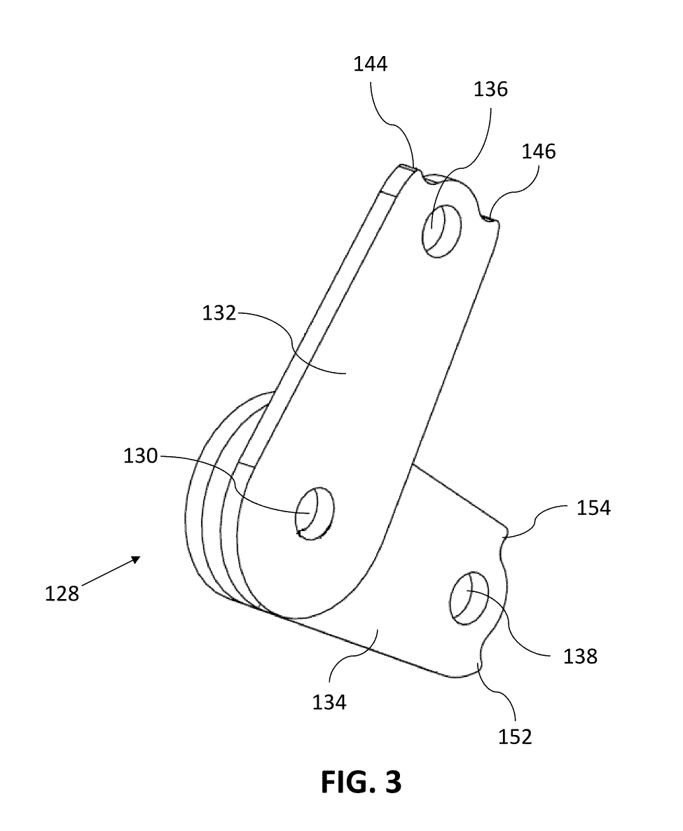

FIG. 3 illustrates a perspective view of an example arrangement of pivot system 128 of dual function tool 100 illustrated in FIG. 1. Pivot system 128 comprises central pivot point 130, first handle linkage member 132, comprising first handle pivot point 136, first handle linkage member first rotation constraint 144, and first handle linkage member second rotation constraint 146. Pivot system 128 further comprises second handle linkage member 134, comprising second handle pivot point 138, a second handle linkage member first rotation constraint 152, and a second handle linkage member second rotation constraint 154.

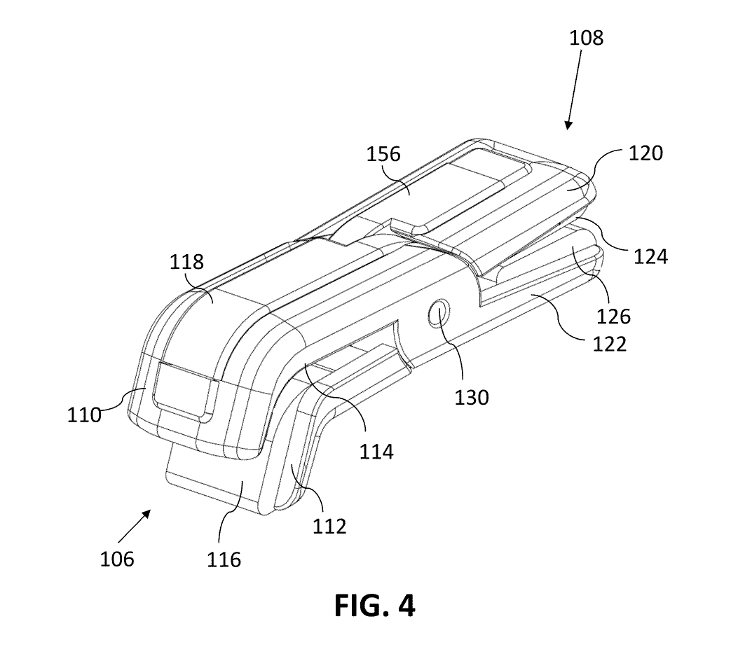

FIG. 4 illustrates a perspective view of an example arrangement of first gripping device 106 and second gripping device 108 of dual function tool 100 illustrated in FIG. 1. First gripping device 106 and second gripping device 108 pivot about central pivot point 130. First gripping device 106 comprises first jaw 110 and second jaw 112, which in turn comprise a pair of opposed surfaces 114 and 116, respectively. First jaw 110 comprises a first jaw bearing portion 118, while second jaw 112 comprises a second jaw bearing portion (not shown).

Second gripping device 108 comprises first jaw 120 and second jaw 122, which in turn comprise a pair of opposed surfaces 124 and 126. First jaw 120 comprises a first jaw bearing portion 156, while second jaw 122 comprises a second jaw bearing portion (not shown).

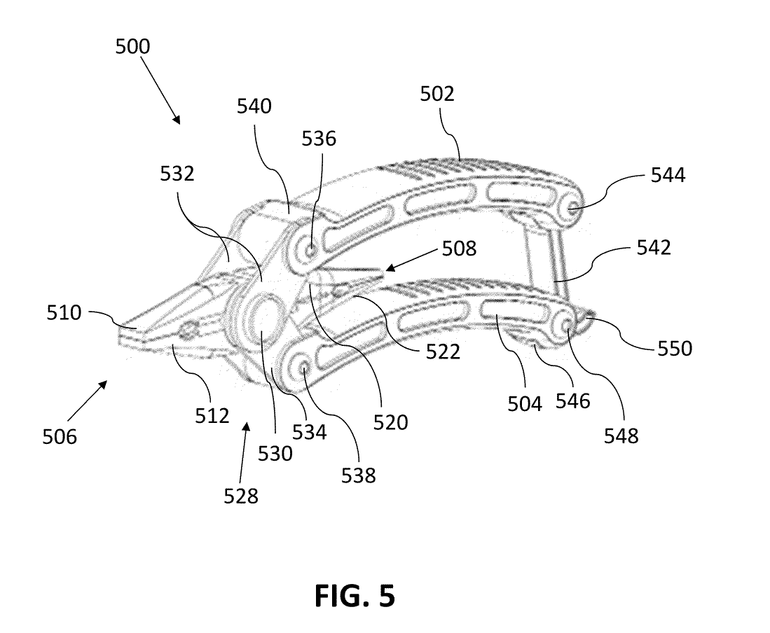

FIG. 5 illustrates a perspective view of an example arrangement of a dual function tool 500 in a first configuration. Dual function tool 500 comprises a first handle 502, a second handle 504, a first gripping device 506, and a second gripping device 508. First gripping device 506 comprises a first jaw 510 and a second jaw 512. Second gripping device 508 comprises a first jaw 520 and second jaw 522.

Dual function tool 500 comprises a pivot system 528, which includes a central pivot point 530. First gripping device 506 and second gripping device 508 pivot about central pivot point 530. Pivot system 528 comprises at least one first handle linkage member 532 and at least one second handle linkage member 534. The distal end of at least one first handle linkage member 532 pivotally connects to first handle 502 at first handle pivot point 536, while the distal end of at least one second handle linkage member 534 pivotally connects to second handle 504 at second handle pivot point 538.

In one embodiment, first handle 502 includes at least one first bearing portion 540. In another embodiment, second handle 504 includes at least one second bearing portion (not shown).

In one embodiment, dual function tool 500 comprises a locking mechanism 542 configured to be selectively engaged by a user to keep dual function tool 500 in a closed position for easier and safer storage. Locking mechanism 542 may pivot about locking mechanism pivot point 544, which may be integrated into at least one of first handle 502 and second handle 504. Locking mechanism may comprise a first hook member 546 configured to selectively engage a locking mechanism engagement point 548. Locking mechanism engagement point 548 may be integrated into at least one of second handle 504 and first handle 502. Locking mechanism 542 may further comprise a second hook member 550 configured to selective engage locking mechanism engagement point 548 when dual function tool is in another configuration.

As illustrated in FIG. 5, dual function tool 500 may be oriented in a first configuration wherein first gripping device 506 extends distally from dual function tool 500 and first handle 502 and second handle 504 are substantially parallel.

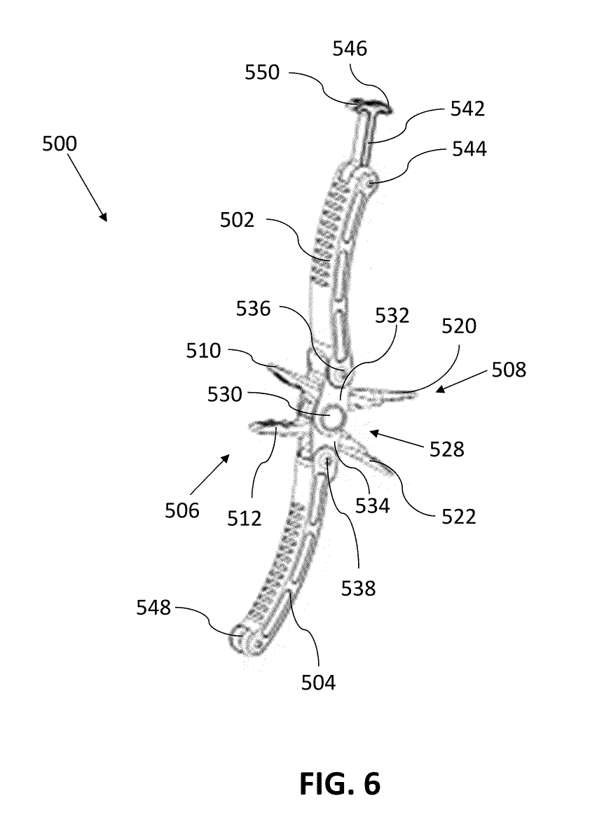

FIG. 6 illustrates a perspective view of an example arrangement of dual function tool 500 in a second configuration. As illustrated in FIG. 6, locking mechanism 542 may be selectively disengaged from locking mechanism engagement point 548, and first handle 502 and second handle 504 may be rotated away from one another.

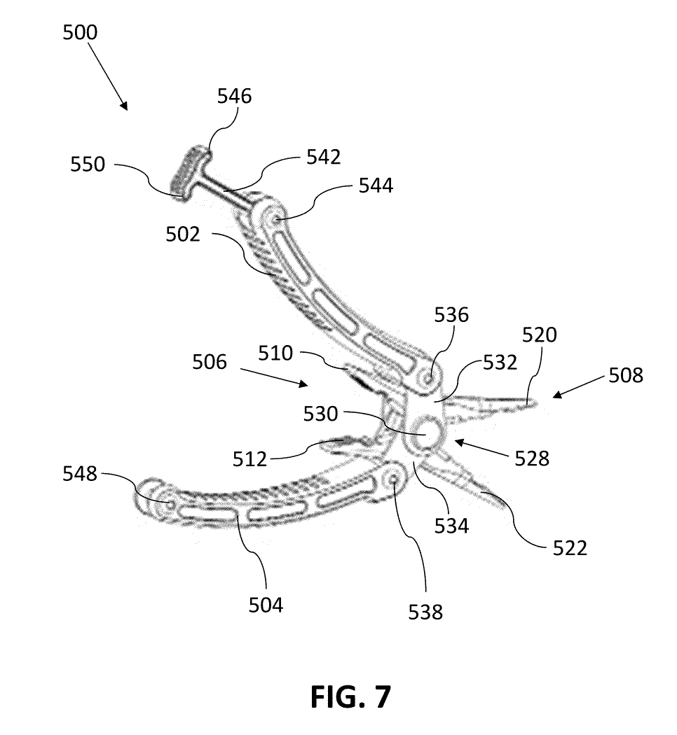

FIG. 7 illustrates a perspective view of an example arrangement of dual function tool 500 in a third configuration wherein second gripping device 508 extends distally from dual function tool 500 and first handle 502 and second handle 504 are substantially parallel.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. As used in the specification and the claims, the singular forms “a,” “an,” and “the” include the plural. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art, having the benefit of the present application. Therefore, the application, in its broader aspects, is not limited to the specific details, illustrative examples shown, or any apparatus referred to. Departures may be made from such details, examples, and apparatuses without departing from the spirit or scope of the general inventive concept.

1. A dual function tool comprising:
a first handle comprising a first bearing portion;
a second handle comprising a second bearing portion; and
a first gripping device and a second gripping device,
wherein the first gripping device and second gripping device pivot about a central pivot point, and
wherein at least one of the first bearing portion and the second bearing portion is configured to transfer force to at least one of the first gripping device and the second gripping device.

2. The dual function tool of claim 1, further comprising at least one linkage member connecting at least one of the first handle and the second handle to the central pivot point.

3. The dual function tool of claim 1, wherein the first handle comprises a first handle pivot point, and wherein the second handle comprises a second handle pivot point.

4. The dual function tool of claim 3, further comprising a first handle linkage member connecting the first handle pivot point to the central pivot point, and a second handle linkage member connecting the second handle pivot point to the central pivot point.

5. The dual function tool of claim 2, wherein the at least one linkage member comprises at least one rotation constraint disposed near the proximal end portion of the at least one linkage member.

6. The dual function tool of claim 2, wherein the at least one linkage member comprises a first rotation constraint and a second rotation constraint disposed near the proximal end portion of the at least one linkage member, wherein the first rotation constraint and the second rotation constraint are separated by θ degrees measured from a datum coaxial with a handle pivot point.

7. The dual function tool of claim 1, further comprising a first handle first linkage member and a first handle second linkage member connecting the first handle to the central pivot point.

8. The dual function tool of claim 1, further comprising a second handle first linkage member and a second handle second linkage member connecting the second handle to the central pivot point.

9. The dual function tool of claim 1, wherein one of the first gripping device and the second gripping device comprises at least one of: an oven tong, a hot plate tong, a straight tong, an angled tong, a general purpose plier, a needle-nose plier, a tweezer, a scissor, a wire cutter, a wire stripper, a wire crimper, a hose-clamp plier, a split-ring plier, a needle bent-nose plier, a fence plier, a side-cutting plier, an end-cutting plier, a coil crimping plier, a chain plier, a boot clamp plier, a lock ring plier, a crimper, a bolt cutter, a pruner, a compound plier, a lopper, and a clamp.

10. The dual function tool of claim 1, wherein at least one of the first gripping device and the second gripping device comprise a pair of opposed surfaces, and wherein at least one of the pair of opposed surfaces comprises a silicone.

11. The dual function tool of claim 6, wherein θ is between about 5 degrees and about 180 degrees.

12. The dual function tool of claim 1, wherein at least one of the first gripping device and the second gripping device comprise a pair of opposed surfaces, and further comprising a biasing member biasing the opposed surfaces away from one another.

13. The dual function tool of claim 1, wherein at least one of the first gripping device and the second gripping device comprise a pair of opposed surfaces, and further comprising a biasing member biasing the opposed surfaces toward one another.

14. A dual function tool comprising:
a first handle comprising a first bearing portion;
a second handle comprising a second bearing portion;
a first gripping device and a second gripping device,
wherein the first gripping device and second gripping device pivot about a central pivot point,
wherein at least one of the first bearing portion and the second bearing portion is configured to transfer force to at least one of the first gripping device and the second gripping device;
a first handle linkage member connecting the first handle pivot point to the central pivot point; and
a second handle linkage member connecting the second handle pivot point to the central pivot point.

15. The dual function tool of claim 14, wherein one of the first gripping device and the second gripping device comprises at least one of: an oven tong, a hot plate tong, a straight tong, an angled tong, a general purpose plier, a needle-nose plier, a tweezer, a scissor, a wire cutter, a wire stripper, a wire crimper, a hose-clamp plier, a split-ring plier, a needle bent-nose plier, a fence plier, a side-cutting plier, an end-cutting plier, a coil crimping plier, a chain plier, a boot clamp plier, a lock ring plier, a crimper, a bolt cutter, a pruner, a compound plier, a lopper, and a clamp.

16. The dual function tool of claim 14, wherein at least one of the first gripping device and the second gripping device comprise a pair of opposed surfaces, and wherein at least one of the pair of opposed surfaces comprises a silicone.

17. The dual function tool of claim 14, wherein at least one of the first gripping device and the second gripping device comprise a pair of opposed surfaces, and further comprising a biasing member biasing the opposed surfaces away from one another.

18. The dual function tool of claim 14, wherein at least one of the first gripping device and the second gripping device comprise a pair of opposed surfaces, and further comprising a biasing member biasing the opposed surfaces toward one another.

19. A dual function tool comprising:
a first handle comprising a first bearing portion;
a second handle comprising a second bearing portion;
a first gripping device and a second gripping device,
wherein the first gripping device and second gripping device pivot about a central pivot point,
wherein at least one of the first bearing portion and the second bearing portion is configured to transfer force to at least one of the first gripping device and the second gripping device;
a first handle first linkage member and a first handle second linkage member connecting the first handle to the central pivot point; and
a second handle first linkage member and a second handle second linkage member connecting the second handle to the central pivot point.

20. The dual function tool of claim 19, wherein one of the first gripping device and the second gripping device comprises at least one of: an oven tong, a hot plate tong, a straight tong, an angled tong, a general purpose plier, a needle-nose plier, a tweezer, a scissor, a wire cutter, a wire stripper, a wire crimper, a hose-clamp plier, a split-ring plier, a needle bent-nose plier, a fence plier, a side-cutting plier, an end-cutting plier, a coil crimping plier, a chain plier, a boot clamp plier, a lock ring plier, a crimper, a bolt cutter, a pruner, a compound plier, a lopper, and a clamp.
